(19) United States
(12) Patent Application Publication
(10) Pub. No.: US 2022/0377847 A1
(43) Pub. Date: Nov. 24, 2022

(54) METHOD FOR MANAGING HEAT, IN PARTICULAR FOR A MOTOR VEHICLE, AND ASSOCIATED CONTROL UNIT

(71) Applicant: Valeo Systemes Thermiques, Le Mesnil Saint-Denis (FR)

(72) Inventors: Erwan Gogmos, Le Mesnil Saint-Denis (FR); Bertrand Puzenat, Le Mesnil Saint-Denis (FR)

(73) Assignee: Valeo Systemes Thermiques, Le Mesnil Saint-Denis (FR)

(21) Appl. No.: 17/765,154

(22) PCT Filed: Sep. 28, 2020
(86) PCT No.: PCT/FR2020/051688

§ 371 Date: Mar. 30, 2022

(30) Foreign Application Priority Data
Oct. 1, 2019 (FR) 1910891

(51) Int. Cl. H05B 1/02

(52) U.S. Cl. CPC H05B 1/0244; H05B 1/0236; H05B 2203/007

(57) ABSTRACT

The invention relates to a method for managing heat in the event of detecting overheating of an electrical heating device, in particular for a motor vehicle, comprising a plurality of resistive elements configured to be supplied with electric power using a control signal by pulse width modulation according to a setpoint. According to the invention, the method comprises the following steps: activating a first phase (P1) of gradual adjustment of the setpoint in a first direction of progression, and repeating the first phase (P1) of adjustment until the recorded duty cycle of the control signal by pulse width modulation (PWM_(sub)system) exceeds a determined detection threshold value (PWM_(sub)system_lim_i), and if not, —activating a second phase (P2) of adjustment of the setpoint in a second direction of progression opposite the direction of progression in the first adjustment phase (P1). The invention also relates to a control unit for implementing such a method.

The invention relates to a thermal management method to be applied in case of overheating of an electrical heating device for heating a fluid. It is in particular a question of an electrical heating device with which a motor vehicle is intended to be equipped. Nonlimitingly, the electrical heating device may be configured to heat, for example, an air flow intended to flow through the heating device. The invention may be applied equally well to a high-voltage electrical heating device as to a low-voltage electrical heating device.

The invention especially applies to a motor-vehicle heating and/or ventilation and/or air-conditioning apparatus comprising such a heating device.

A motor vehicle is commonly equipped with such a heating and/or ventilation and/or air-conditioning apparatus, which is intended to regulate aerothermal parameters of an air flow intended to be delivered to the passenger compartment, and in particular the temperature of the air flow. To do this, the apparatus generally comprises one or more heat-treatment devices, and especially an electrical heating device (also called an electrical radiator) for heating a fluid such as an air flow.

The electrical heating device comprises electrical heating modules. By way of example, the electrical heating modules may be arranged so as to be directly exposed to an air flow flowing through the electrical heating device.

According to one known solution, the heating modules comprise resistive elements, for example PTC resistive elements (PTC being the acronym of positive temperature coefficient) such as PTC ceramics, which are also referred to as PTC ceramic resistors.

It is a question of elements the resistance of which varies greatly as a function of temperature. More precisely, the ohmic value of PTC resistive elements increases very rapidly beyond a preset temperature threshold.

The resistive elements may be supplied by an on-board electrical voltage source, namely batteries. An electrical connector may be connected to the voltage source located on-board the vehicle, so as to allow the required electrical power to be supplied to the electrical heating device, and especially to the resistive elements. Furthermore, the resistive elements are controlled by an electronic control unit that generally comprises an electrical supply circuit. The electrical supply circuit is for example mounted on a printed circuit board.

In particular in the case of a high-voltage electrical heating device, it may be a question of a main heating device of the vehicle, which may therefore be very powerful.

In case of overheating, the device may reach at at least one point a temperature limit of correct operation of the system. PTC resistive elements are used to protect against excessive overheating that could, for example, start a fire, thus allowing the safety of passengers to be guaranteed.

However, certain components close to the electrical heating device, such as for example plastic parts of the heating and/or ventilation and/or air-conditioning apparatus, may be more sensitive especially under certain conditions, for example in the case of a high temperature when the shutters of the heating and/or ventilation and/or air-conditioning apparatus are closed, intentionally or due to an undetected mechanical failure.

It is therefore advantageous to control the temperature of the electrical heating device, in order to avoid degrading surrounding components.

The objective of the invention is to provide a thermal management solution to be applied in case of detection of overheating of the electrical heating device, allowing the aforementioned drawbacks of the prior art to be at least partially avoided.

To this end, one subject of the invention is a thermal management method to be applied in case of detection of overheating of an electrical heating device, especially for a motor vehicle, said device comprising a plurality of resistive elements configured to be supplied electrically by an electrical voltage source, wherein the electrical supply of at least one subset of resistive elements is controlled using a pulse-width-modulated control signal depending on a power setpoint, or temperature setpoint, or current setpoint, or resistance setpoint.

According to the invention, said method comprises the following steps:
activating a first phase of gradually regulating said setpoint in a first direction of change, the first regulating phase comprising the following sub-steps: regulating said setpoint in first predefined increments; for each regulated setpoint value, determining, for the duty cycle of said control signal, a corresponding detection threshold value representative of overheating of said at least one subset of resistive elements, depending on the regulated setpoint value; in each iteration of the first regulating phase, noting the duty cycle of said control signal and comparing it with the determined corresponding detection threshold value of the duty cycle of said control signal,
reiterating the first regulating phase as long as the noted duty cycle of the pulse-width-modulated control signal is beyond the determined detection threshold value,
but otherwise activating a second phase of regulating said setpoint, in a second direction of change opposite to the direction of change of the first phase.

Preferably, the first phase is a derating phase, i.e. a phase in which said setpoint is limited in a first direction of change.

The derating or limiting first phase comprises the following sub-steps:
limiting said setpoint in first predefined increments allowing a derating level i to be reached,
for each limited setpoint value, determining, for the duty cycle of said control signal, a corresponding detection threshold value representative of overheating of said at least one subset of resistive elements, depending on the limited setpoint value,
in each iteration of the derating or limiting first phase, noting the duty cycle of said control signal and comparing it with the determined corresponding detection threshold value of the duty cycle of said control signal.

The derating or limiting first phase is reiterated as long as the noted duty cycle of the pulse-width-modulated control signal is beyond the determined detection threshold value.

Said method may also comprise one or more of the following features, implemented separately or in combination.

The second regulating phase is preferably gradual and comprises the following sub-steps:
regulating said setpoint in second predefined increments,
for each regulated setpoint value, determining, for the duty cycle of said control signal, a corresponding detection threshold value representative of overheating,
in each iteration of the second regulating phase, noting the duty cycle of said control signal and comparing it with the determined corresponding detection threshold value of the duty cycle of said control signal,
if the noted duty cycle of the pulse-width-modulated control signal is beyond the determined detection threshold value, reactivating the first regulating phase,
but otherwise reiterating the second phase of regulating said setpoint.

Preferably, the second regulating phase is a setpoint-uprating or -increasing phase, comprising the following sub-steps:
increasing said setpoint in second predefined increments,
for each increased setpoint value, determining, for the duty cycle of said control signal, a corresponding detection threshold value representative of overheating,
in each iteration of the uprating or increasing second phase, noting the duty cycle of said control signal and comparing it with the determined corresponding detection threshold value of the duty cycle of said control signal,
if the noted duty cycle of the pulse-width-modulated control signal is beyond the determined detection threshold value, reactivating the derating first phase, but otherwise reiterating the second phase of uprating or increasing said setpoint. In particular, the second phase of uprating or increasing said setpoint may be reiterated potentially until the prevailing setpoint is reached. More precisely, it is the non-limited prevailing setpoint that may potentially be reached. It is in particular a question of the setpoint request received from the control unit. This setpoint may potentially but not necessarily be the initial setpoint. According to another option, this setpoint may have changed and no longer be the initial setpoint.

The increase in said setpoint in the second predefined increments in particular allows a level of increase j to be reached. In particular, if the second predefined increments are equal to the first predefined increments, the level of increase j corresponds to a derating level i.

Said method may comprise a step of measuring the supply voltage, and the detection threshold value of the duty cycle of said control signal is also determined depending on the measured supply voltage.

Said method may comprise the following steps:
in the first regulating phase, comparing the regulated value of said setpoint with a limit setpoint value,
if the regulated value of said setpoint reaches the limit setpoint value, generating a command to stop the electrical supply of said at least one subset of resistive elements for a predefined stoppage time.

A command to resume the electrical supply of said at least one subset of resistive elements may be generated at the end of the predefined stoppage time.

Alternatively, the command to resume the electrical supply may be dependent on a predefined criterion, such as the temperature of a carrier of the electrical supply circuit of the resistive elements.

Resumption of the electrical supply of said at least one subset of resistive elements is commanded with a resumption setpoint set to a predetermined value lower than or equal to a permitted maximum setpoint value.

The method may further comprise the following steps:
noting the temperature of a carrier of the electrical supply circuit of the resistive elements,
determining depending on the noted temperature whether said at least one subset of resistive elements is in a minimum heating state, and
activating the first regulating phase when a minimum heating state of said at least one subset of resistive elements is determined.

In the absence of detection of a minimum heating state of said at least one subset of resistive elements, the first regulating phase is not activated and said method may be reiterated from the start.

The temperature of said carrier is for example noted subsequently to the predefined stoppage time of the electrical supply of said at least one subset of resistive elements.

The command to resume the electrical supply of said at least one subset of resistive elements is generated with a resumption setpoint if a minimum heating state of said at least one subset of resistive elements is determined, depending on the noted temperature of said carrier.

In the absence of detection of a minimum heating state of said at least one subset of resistive elements, the electrical supply may restart with a permitted maximum setpoint.

According to a first embodiment, the noted temperature of said carrier is compared with a predefined limit temperature representative of minimum heating of the electrical heating device.

According to a second embodiment, the variation in the temperature of the carrier of the electrical supply circuit of the resistive elements is monitored over a predefined period of time, for example over the predefined stoppage time of the electrical supply of said at least one subset of resistive elements, and compared with a predefined limit temperature variation representative of minimum heating of the electrical heating device.

According to one variant embodiment, the resistive elements are resistive elements of negative temperature coefficient.

The resistive elements may be resistive elements of positive temperature coefficient, the setpoint for example being a power setpoint. In this case, the first regulating phase is a derating phase in which the power setpoint is gradually decreased in the first predefined increments as long as the noted duty cycle of the pulse-width-modulated control signal is higher than the detection threshold value determined in the first regulating phase, and the second regulating phase is an uprating phase in which the power setpoint is increased when the noted duty cycle of the pulse-width-modulated control signal is lower than or equal to the detection threshold value determined in the second regulating phase.

The first regulating phase may be iterated with a predefined period. The predefined period may be shorter than 10 s, and for example of the order of 4 s.

The second regulating phase may be iterated with a predefined period. This predefined period may be the same as for the first regulating phase.

Said first and/or second predefined increments may be constant.

The second predefined increments may be equal to the first predefined increments.

Alternatively, said first and/or second predefined increments are variable. According to one example of embodiment, from a predefined number of iterations of the first regulating phase, the first predefined increments are increased so as to accelerate the change of said setpoint and of the duty cycle of said control signal.

According to one preferred embodiment, said setpoint is a power setpoint.

At least two subsets of separate resistive elements are controlled independently by pulse-width modulation of the electrical supply. For each subset, a detection threshold value of the duty cycle of the control signal is defined independently, depending on the nature and/or the number of the resistive elements of the subset.

Prior to the activation of the first regulating phase, overheating of at least one subset of resistive elements of the electrical heating device is detected in a preliminary step, when the duty cycle of the pulse-width-modulated control signal of said at least one subset of resistive elements is beyond a predefined detection threshold value of the duty cycle of the pulse-width-modulated control signal, which value is representative of overheating of said at least one subset of resistive elements.

The invention also relates to a control unit for an electrical heating device comprising a plurality of resistive elements configured to be electrically supplied by an electrical voltage source, the control unit being configured to generate a pulse-width-modulated control signal for controlling the electrical supply of the resistive elements depending on a power setpoint, or a temperature setpoint, or a current setpoint, or a resistance setpoint. The control unit comprises at least one processing means for:
activating a first phase of gradually regulating said setpoint in a first direction of change, the first regulating phase comprising the following sub-steps: regulating said setpoint in first predefined increments; for each regulated setpoint value, determining, for the duty cycle of said control signal, a corresponding detection threshold value representative of overheating of said at least one subset of resistive elements, depending on the regulated setpoint value; in each iteration of the first regulating phase, noting the duty cycle of said control signal and comparing it with the determined corresponding detection threshold value of the duty cycle of said control signal,
reiterating the first regulating phase as long as the noted duty cycle of the pulse-width-modulated control signal is beyond the determined detection threshold value,
but otherwise activating a second phase of regulating said setpoint, in a second direction of change opposite to the direction of change of the first phase.

Other features and advantages of the invention will become more clearly apparent on reading the following description, which is given by way of illustrative and nonlimiting example, and the appended drawings, in which:

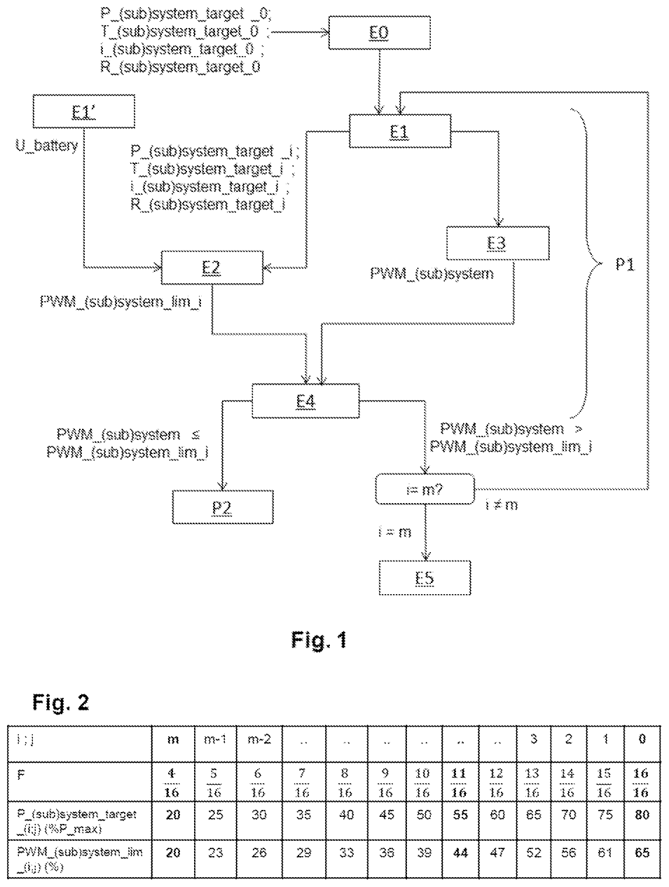

FIG. 1 shows a flowchart of various steps of the thermal management method, and in particular of a first setpoint-regulating phase according to the invention.

FIG. 2 is a table of values representing one example of change of the detection threshold value of the duty cycle of the pulse-width-modulated control signal depending on the electrical power setpoint for a constant voltage.

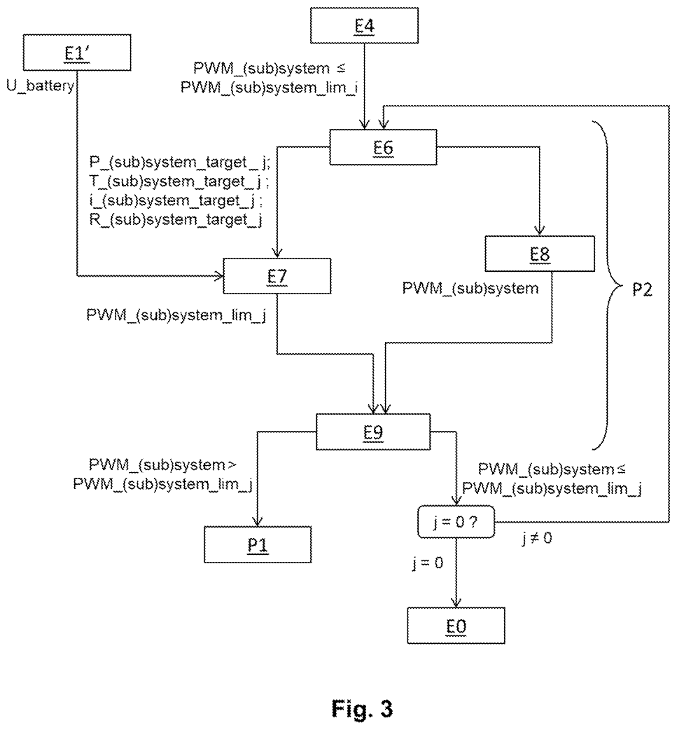

FIG. 3 shows a flowchart of various steps of the thermal management method, and in particular of a second setpoint-regulating phase in which the setpoint is regulated in a direction of change opposite to that of the first regulating phase.

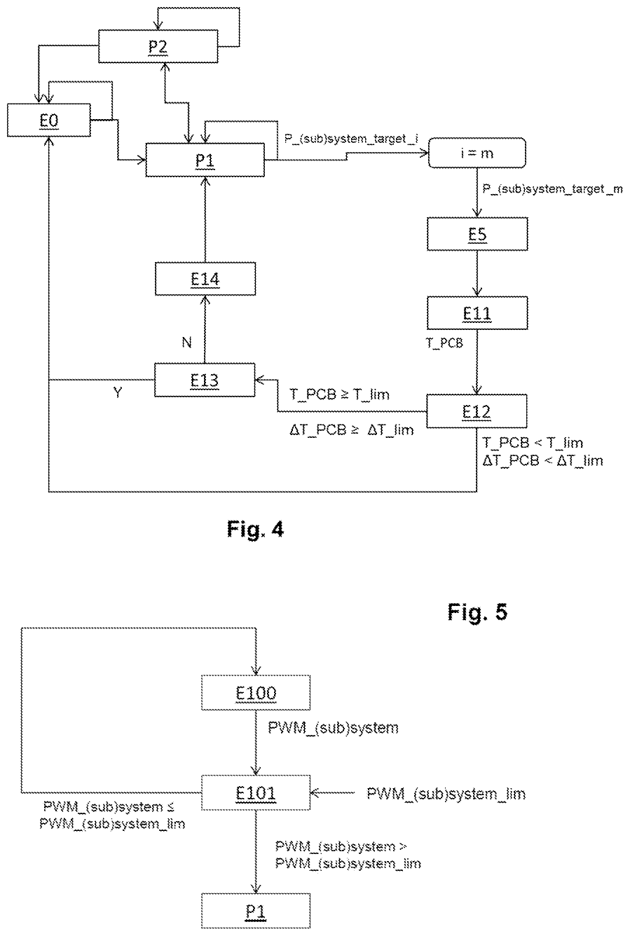

FIG. 4 shows a flowchart of various steps of the thermal management method in a case where the electrical supply of the resistive elements was cut following implementation of the first regulating phase.

FIG. 5 shows an example of a flowchart of various preliminary steps of a method for detecting overheating before activation of the first regulating phase of the thermal management method according to the invention.

In these figures, identical elements have the same reference signs.

The following embodiments are examples. Although the description refers to one or more embodiments, this does not necessarily mean that each reference relates to the same embodiment, or that the features apply only to a single embodiment. Individual features of various embodiments may also be combined or interchanged in order to create other embodiments.

In the description, some elements may be indexed, such as first element or second element. In this case, this is a simple index for differentiating and designating elements that are similar but not identical. This indexation does not imply that one element takes priority over another and such designations may easily be interchanged without departing from the scope of the present description. This indexation does not imply an order in time either.

The invention relates to the field of a heating and/or ventilation and/or air-conditioning apparatus (not shown in the figures) employing an air flow, with which apparatus a motor vehicle is intended to be equipped with a view to regulating the aerothermal parameters of the air flow, which is delivered to one or more regions of the passenger compartment of the vehicle.

The invention more particularly relates to a motor-vehicle electrical heating device (also called an electrical radiator) with which such an apparatus is especially equipped. It is a question of an electrical device for heating a fluid. Nonlimitingly, it may be a question of a device for heating an air flow. Below, the description is given with reference to an air flow, but the invention may be applied to another fluid.

In particular, it may be a question of a high-voltage radiator or electrical heating device. The expressions “high voltage” and “high-voltage” define, for example, a voltage higher than 90 V or 120 V. As a variant, it may be a question of a low-voltage radiator.

The electrical heating device is configured to convert electrical energy drawn for example from the vehicle into thermal energy that is transferred to an air flow flowing through the heating and/or ventilation and/or air-conditioning apparatus.

The electrical heating device may comprise a predefined number of heating modules. These heating modules may be arranged so as to be directly exposed to the air flow flowing through the electrical heating device.

More precisely, the heating modules may each comprise resistive elements. The electrical heating device therefore comprises a plurality of resistive elements configured to be supplied electrically by an electrical voltage source.

The resistive elements may be resistive elements of positive temperature coefficient (PTC). The resistive elements for example take the form of PTC ceramics, and for example of the PTC ceramics known as PTC ceramic resistors. As a variant, it may be a question of resistive elements of negative temperature coefficient (NTC).

The electrical heating device generally furthermore comprises an electronic control unit for controlling the heating modules. Such a control unit comprises one or more electronic and/or electrical components. The control unit especially comprises an electrical supply circuit (not shown) for supplying the resistive elements. The electrical supply circuit is for example mounted on an electrical circuit carrier such as a printed circuit board (or PCB to use the well-known acronym).

By way of example, the electrical supply circuit comprises transistors (not shown), each allowing the passage of current through a predefined number of heating modules to be permitted or not.

The resistive elements are intended to be supplied by an electrical power source (not shown), such as batteries, of the vehicle for example. The electrical supply of the resistive elements is controlled by pulse-width modulation (or PWM to use the well-known acronym).

The control unit is configured to generate a pulse-width-modulated control signal for controlling the electrical supply of the resistive elements, and in particular of at least one subset of resistive elements. Distinct subsets of resistive elements may be independently controlled by pulse-width modulation. The resistive elements, and in particular at least one subset of resistive elements forming a subsystem, may be supplied electrically depending on a setpoint.

According to one preferred embodiment, the setpoint is an electrical power setpoint P_(sub)system_target_0 (FIG. 1). The heating device is controlled in a closed-loop mode. As a variant, the resistive elements may be supplied electrically depending on a temperature setpoint T_(sub)system_target_0. It is possible to envisage an alternative with a constant-voltage current setpoint i_(sub)system_target_0, or potentially a resistance setpoint R_(sub)system_target_0. The “sub” prefix has been written between parentheses to indicate that the setpoint regards either a subset of resistive elements or all of the resistive elements.

Method

FIG. 1 schematically shows the steps of a thermal management method applied following detection of overheating of the electrical heating device, which is made up of one or more subsets of resistive elements. This especially allows a specific strategy to be applied to various hot spots, for example when the electrical heating device is installed in a so-called multi-zone heating and/or ventilation and/or air-conditioning apparatus (in this case the heating modules may be dedicated to heating separate zones of the passenger compartment).

It is possible to apply such thermal management to all the resistive elements together, or independently to each subset of resistive elements, each subset being controlled using one transistor or a plurality of transistors. The strategy also varies depending on the nature of the resistive elements and for example depending on whether they are resistive elements of positive temperature coefficient (PTC) or negative temperature coefficient (NTC).

At the start of the method, the resistive elements are controlled taking into account an initial setpoint that corresponds to the minimum between the setpoint received from the control unit controlling the resistive elements and a permitted maximum setpoint. By way of illustration, for a power setpoint, the initial power setpoint P_(sub)system_target_0 or permitted maximum setpoint is for example equal to 80% of a maximum power P_max.

The thermal management method is triggered when overheating is detected in a preliminary step E0. For example, overheating may be detected by monitoring the change in the duty cycle PWM_(sub)system of the control signal of at least one subset of resistive elements forming a subsystem. In the rest of the description, the duty cycle of the pulse-width-modulated control signal either of one subsystem or of all of the resistive elements has been designated PWM_(sub)system, with “sub” between parentheses.

Generally, on detection of overheating, the setpoint is gradually regulated in one direction, so as to be increased or reduced according to the circumstances. This regulation is reiterated until the duty cycle of the pulse-width-modulated control signal is no longer representative of overheating. In this case, the setpoint may be regulated in the other direction, advantageously also gradually, until it returns to the starting setpoint.

First Regulating Phase

Thus, on detection of overheating, a first phase P1 of gradually regulating the setpoint in a first direction of change is activated. It is in particular a question of a derating or limiting phase, in which the setpoint is limited, i.e. decreased.

The first phase P1 comprises a step E1 of regulating, and in particular of limiting, the setpoint. By way of example, in the case of a power setpoint and of PTC resistive elements, regulation is achieved by decreasing the power setpoint. It is therefore in this example a question of a phase of derating the power setpoint.

The setpoint is regulated in first predefined increments. The increments chosen reflect a compromise between the inertia of the electrical heating device and the desired reactivity.

The predefined increments may be constant. They are for example of the order of 1/16 of the permitted maximum setpoint P_(sub)system_target_0; T_(sub)system_target_0; i_(sub)system_target_0; R_(sub)system_target_0. Thus, in the example where regulation is achieved by derating the setpoint such as the power setpoint, in each iteration of the derating phase the power setpoint is decreased by 1/16 of the permitted maximum setpoint, and thus passes from a factor 16/16 in step E0 to a factor 15/16 in the first iteration of the derating phase, then to 14/16 in case of a second iteration of the derating phase, then to 13/16 and so on.

Alternatively, the first increments may be variable. According to one example of embodiment, from a predefined number of iterations of the first regulating phase P1, the first predefined increments are increased so as to accelerate the change of the setpoint and of the duty cycle. In the preceding case of a first phase of derating the power setpoint for example, the first predefined increments may be quite small to start with and may be amplified with the iterations of the derating first phase, so as to accelerate the decrease in the power setpoint and the duty cycle, for example with larger increments.

In each stage of regulation of order i, i.e. in this example in each limitation of the setpoint allowing a derating level i to be reached, the setpoint passes to a regulated/limited setpoint value P_(sub)system_target_i; T_(sub)system_target_i; i_(sub)system_target_i; R_(sub)system_target_i.

The first regulating phase comprises a step E2 of determining a corresponding detection threshold value for the duty cycle of the pulse-width-modulated control signal of the predefined number of resistive elements.

This threshold value may be determined for one or more subsystems, i.e. for one or more sets of heating modules controlled by one or more transistors, or for the whole system, i.e. all of the resistive elements of all the heating modules. When the thermal management is applied to a subset, the detection threshold value is designated PWM_subsystem_lim_i. For each independently controlled subset, detection threshold values may be defined independently, depending on the nature and/or the number of resistive elements of the subset. When it is a question of applying thermal management to the whole system, the detection threshold value is designated PWM_system_lim_i. In the rest of the description, the detection threshold value defined for a subset or for all of the resistive elements is designated PWM_(sub)system_lim, with “sub” in parentheses.

The detection threshold value is representative of overheating of the subsystem or of the entire system. This threshold value is determined depending on the regulated setpoint value P_(sub)system_target_i; T_(sub)system_target_i; i_(sub)system_target_i; R_(sub)system_target_i.

In particular, the detection threshold value PWM_(sub)system_lim_i may be defined depending on the pair consisting of the supply voltage U_battery and of the regulated setpoint, a matrix of possible detection threshold values then being obtained.

In this case, a step E1′ in which the supply voltage U_battery is measured may be implemented beforehand. This step E1′ may be implemented using a sensor for measuring voltage. The supply voltage U_battery may be constant.

The detection threshold value PWM_(sub)system_lim_i of the duty cycle of said control signal may be read from a table based on the setpoint and potentially on the supply voltage U_battery, the table being stored in a command of the electrical heating device.

Considering the case of a power setpoint for PTC resistive elements, an example of detection threshold values PWM_(sub)system_lim_i is given by way of illustration in FIG. 2. The table of values in FIG. 2 is given for a constant supply voltage, for example of 306 V, and considering the initial permitted maximum power setpoint to be 80% of the maximum power P_max. For this initial power setpoint, the detection threshold value PWM_(sub)system_lim is 65%. No derating of the setpoint having taken place, the derating level i is equal to 0.

In a first iteration of the derating phase, the power setpoint is decreased by 1/16, therefore passing from a factor F of 16/16 to 15/16, this for example corresponding to 75% of the maximum power P_max, and the corresponding detection threshold value PWM_(sub)system_lim_i is 61%. The setpoint reaches the derating level i=1.

If the power setpoint is decreased again, the factor F passes to 14/16, this for example corresponding to 70% of the maximum power P_max, and the corresponding detection threshold value PWM_(sub)system_lim_i is 56% and so on. The setpoint reaches the derating level i=2.

According to another alternative, it is possible for the detection threshold value for the duty cycle of the control signal to be computed by means of an algorithm (not described in detail herein) stored in a command of the electrical heating device.

Referring again to FIG. 1, in a step E3, the duty cycle PWM_(sub)system of the pulse-width-modulated control signal of the predefined number of resistive elements may be noted.

In step E4, the value of the duty cycle PWM_(sub)system of the control signal noted in step E3 is compared with the corresponding detection threshold value PWM_(sub)system_lim_i of the duty cycle of the control signal determined in step E2.

This comparing step E4 may be carried out for one or more subsystems, i.e. for one or more sets of heating modules controlled by one or more transistors, or for the whole system, i.e. all of the resistive elements of all the heating modules.

This comparing step E4 may be implemented by a processing means such as a comparator.

If the noted duty cycle PWM_(sub)system of the pulse-width-modulated control signal is beyond the determined detection threshold value PWM_(sub)system_lim_i, the first regulating phase P1 is reiterated. This regards steps E1 to E4 described above. The noted value of the duty cycle may cross the detection threshold value by becoming higher or lower than it, depending on the nature of the resistive elements. For example, in the case of PTC resistive elements, if the noted value of the duty cycle PWM_(sub)system is higher, and more precisely strictly higher, than the determined detection threshold value PWM_(sub)system_lim_i of the duty cycle, this means that the subsystem or the entire device is still overheated, and the first regulating phase P1 is reiterated.

In each iteration i, the detection threshold value PWM_(sub)system_lim_i of the duty cycle of the control signal is redetermined depending on the regulated setpoint value P_(sub)system_target_i; T_(sub)system_target_i; i_(sub)system_target_i; R_(sub)system_target_i.

The first regulating phase P1 is reiterated as long as the noted duty cycle PWM_(sub)system of the pulse-width-modulated control signal is beyond the determined detection threshold value PWM_(sub)system_lim_i.

For example, in the preceding case of a power setpoint and of PTC resistive elements, the power setpoint P_(sub)system_target_i is gradually decreased in the first predefined increments, for example in increments of 1/16 of the permitted maximum setpoint in each iteration i, as long as the noted duty cycle PWM_(sub)system of the pulse-width-modulated control signal is higher, and more precisely strictly higher, than the detection threshold value PWM_(sub)system_lim_i.

In order to facilitate comprehension and to illustrate one example of implementation of the first regulating phase P1, reference is again made to the nonlimiting example of FIG. 2. In the derating phase, after a first decrease of the power setpoint P_(sub)system_target_i to 75% of the maximum power P_max, the value of the duty cycle PWM_(sub)system of the control signal is noted and compared with the corresponding detection threshold value PWM_(sub)system_lim_i, in this example 61%. If the noted value of the duty cycle PWM_(sub)system of the control signal is higher than the detection threshold value PWM_(sub)system_lim_i, the power setpoint is decreased again. In a purely illustrative arbitrary fashion, if the noted value of the duty cycle PWM_(sub)system of the control signal is for example 72% whereas the threshold value is 61%, the derating phase is reiterated.

The power setpoint P_(sub)system_target_i is therefore again decreased, this time to 70% of the maximum power P_max, and the corresponding detection threshold value PWM_(sub)system_lim_i is in this example 56%. In a purely illustrative arbitrary fashion, if the noted value of the duty cycle PWM_(sub)system of the control signal is for example 63% whereas the threshold value is 56%, the derating phase is reiterated again while decreasing the power setpoint P_(sub)system_target_i to 65% of the maximum power P_max, then if necessary to 60% of the maximum power P_max, and so on.

Referring again to FIG. 1, according to one option, the possible iterations i of the first regulating phase P1 may be limited.

This limitation may be dependent on a limit setpoint value P_(sub)system_target_m; T_(sub)system_target_m; i_(sub)system_target_m; R_(sub)system_target_m. This means that if the regulated setpoint value reaches or passes beyond the limit setpoint value, the first phase P1 is not reiterated. In this case, the number of iterations i may vary from 1 to m, m corresponding to a maximum number of iterations (see FIG. 2).

The limit setpoint value may be predefined. For example, also with reference to the table in FIG. 2, in the case of a first phase P1 of derating a power setpoint for PTC resistive elements, and considering the, non-limited, initial permitted power setpoint P_(sub)system_target_0, to be 80% of the maximum power P_max, the limit setpoint value P_(sub)system_target_m may be 4/16 of the permitted maximum power setpoint, this for example corresponding to 20% of the maximum power P_max. In the particular example of a first phase of derating the power setpoint in predefined constant increments of 1/16 of the permitted maximum setpoint, the power setpoint P_(sub)system_target_i may be decreased m times, which in this example corresponds to twelve times, before reaching the limit value P_(sub)system_target_m.

If the regulated value P_(sub)system_target_i of the setpoint reaches this limit setpoint value P_(sub)system_target_m, i.e. if i=m, at the end of step E4, the first phase P1 is stopped and a command to stop the electrical supply of the resistive elements may be generated in step E5. The electrical supply may be stopped for a predefined stoppage time, which may be around 2 min, and for example 130 s.

In the contrary case, if the regulated setpoint value P_(sub)system_target_i does not reach the limit setpoint value P_(sub)system_target_m, or if i≠m, at the end of step E4, steps E1 to E4 may be reiterated.

According to one alternative, the limit setpoint value may not be predefined but may be computed by means of an algorithm stored in a command of the electrical heating device. Such an algorithm may in particular take into account the temperature of the carrier of the electrical circuit.

The first regulating phase P1 is advantageously iterated or reiterated with a predefined period. The predefined period may be shorter than 10 s, and for example of the order of 4 s. This leaves the heating device time to react without being too slow.

Alternatively, the period may be variable. The period may depend for example on a degree of overheating. This degree of overheating may be absolute or a percentage for example found by dividing the actual noted duty cycle PWM_(sub)system of the pulse-width-modulated control signal by the detection threshold value PWM_(sub)system_lim_i. The period may be inversely related to the degree of overheating, i.e. the higher the degree of overheating, the shorter the period.

Second Regulating Phase

If at the end of the comparison of step E4, the noted duty cycle PWM_(sub)system of the pulse-width-modulated control signal has not passed beyond the detection threshold value PWM_(sub)system_lim_i, a second phase P2 of regulating the setpoint may be activated. It is in particular a question of an uprating or increasing phase, in which the setpoint is increased again.

Returning to the particular case of a heating device comprising PTC resistive elements, if the noted value of the duty cycle PWM_(sub)system is lower than or equal to the detection threshold value PWM_(sub)system_lim_i of the duty cycle, the first phase P1 is stopped and the second regulating phase P2 is activated.

Regulation in the second phase P2 is carried out in a second direction of change opposite to the direction of change of the first phase P1.

For example, in the previous case of a power setpoint and of PTC resistive elements, the power setpoint is raised in the second regulating phase P2.

The second regulating phase P2, which in particular is an uprating or increasing phase, is advantageously also gradual. With reference to FIG. 3, the second regulating phase P2 may comprise a step E6 of regulating the setpoint in the second predefined increments. In each stage of regulation of order j, the setpoint is adjusted by one second predefined increment to a regulated setpoint value P_(sub)systemtarget_j; T_(sub)system_target_j; i_(sub)system_target_j; R_(sub)system_target_j.

As above, the increments chosen reflect a compromise between the inertia of the electrical heating device and the desired reactivity. The second predefined increments may be constant. They may be equal to the first predefined increments. In this case, the index j is equal to the index i. The second predefined increments are for example 1/16 of the permitted maximum setpoint. Thus, in the preceding example, in each iteration j of the uprating second phase P2, the power setpoint P_(sub)system_target_j is raised by 1/16 of the permitted maximum setpoint.

Each level of increase j corresponds, in the described example, to one derating level i with respect to the initial setpoint.

In particular, in the first iteration of the second regulating phase P2, the last setpoint value obtained in the first regulating phase P1 is adjusted by one second predefined increment.

For example, in a purely illustrative arbitrary manner, returning to the preceding example and also referring to FIG. 2, if after the power setpoint P_(sub)system_target_i has been decreased, for example to the factor F of 12/16, which corresponds to 60% of the maximum power P_max, the noted value of the duty cycle PWM_(sub)system of the control signal is 45% whereas the threshold value is 47%, the derating phase stops and the uprating second phase P2 is activated. In a first iteration of step E6, the power setpoint is raised to the factor F of 13/16, which for example corresponds to 65% of the maximum power P_max.

Alternatively, the second increments may be variable.

The second regulating phase P2 in addition comprises a step E7 of determining a corresponding detection threshold value PWM_(sub)system_lim_j for the duty cycle of the pulse-width-modulated control signal of the predefined number of resistive elements. This threshold value PWM_(sub)system_lim_j may be determined for one or more subsystems, i.e. for one or more sets of heating modules controlled by one or more transistors, or for the whole system, i.e. all of the resistive elements of all the heating modules. The detection threshold value PWM_(sub)system_lim_j is representative of overheating of the subsystem or of the entire system.

This threshold value PWM_(sub)system_lim_j is determined depending on the regulated setpoint value P_(sub)system_target_j; T_(sub)system_target_j; i_(sub)system_target_j; R_(sub)system_target_j. The detection threshold value PWM_(sub)system_lim_j of the duty cycle of the control signal is again determined in each stage of setpoint regulation j.

In particular, the detection threshold value PWM_(sub)system_lim_j may be defined depending on the pair consisting of the supply voltage U_battery and of the regulated setpoint.

As above, the detection threshold value PWM_(sub)system_lim_j of the duty cycle of said control signal may be read from a table based on the setpoint and potentially on the supply voltage U_battery, the table being stored in a command of the electrical heating device. The example of detection threshold values PWM_(sub)system_lim_j that is given by way of illustration in FIG. 2 for a constant voltage U_battery, for example of 306 V, and considering the, non-limited, permitted maximum power setpoint to be 80% of the maximum power P_max, may also be applied to the second phase P2.

According to another alternative, it is possible for the detection threshold value for the duty cycle of said control signal to be computed by means of an algorithm (not described in detail herein) stored in a command of the electrical heating device.

After the setpoint has been regulated, the duty cycle PWM_(sub)system of the pulse-width-modulated control signal of the predefined number of resistive elements may be noted in a step E8.

In step E9, the value of the duty cycle PWM_(sub)system of the control signal noted in step E8 is compared with the corresponding detection threshold value PWM_(sub)system_lim_j of the duty cycle of said control signal determined in step E7. This comparing step E9 may be implemented by a processing means such as a comparator.

If the noted duty cycle PWM_(sub)system of the pulse-width-modulated control signal is beyond the determined detection threshold value PWM_(sub)system_lim_j, the first phase P1 is reactivated. This regards steps E1 to E4 described above with reference to FIG. 1.

The noted value of the duty cycle may cross the detection threshold value by becoming higher or lower than it, depending on the nature of the resistive elements. For example, in the case of PTC resistive elements, if the noted value of the duty cycle is strictly higher than the defined detection threshold value of the duty cycle, this means that the subsystem or the entire device is overheating. Otherwise, i.e. in the case of PTC resistive elements, if the noted duty cycle PWM_(sub)system of the pulse-width-modulated control signal is lower than or equal to the determined detection threshold value PWM_(sub)system_lim_j, the second regulating phase P2 is reiterated.

In order to facilitate comprehension and to illustrate one example of implementation of the second regulating phase P2, reference is also made to the nonlimiting example of FIG. 2, for the case of a power setpoint for PTC resistive elements, considering the constant voltage U_battery, for example of 306 V, and considering the, non-limited, permitted maximum power setpoint to be 80% of the maximum power P_max.

Starting from a power setpoint P_(sub)system_target_i that was decreased in the derating first phase to 60% of the maximum power P_max, the value of the duty cycle PWM_(sub)system of the control signal is noted and compared with the corresponding detection threshold value PWM_(sub)system_lim_i, which in this example is 47%. If the noted value of the duty cycle PWM_(sub)system of the control signal is lower than or equal to the detection threshold value PWM_(sub)system_lim_i, the derating phase stops and the uprating second phase P2 is activated. For example, in a purely illustrative arbitrary manner, the noted value of the duty cycle PWM_(sub)system of the control signal is 45% whereas the threshold value is 47%. The power setpoint is raised to 13/16 of the permitted maximum power setpoint, this corresponding for example to 65% of the maximum power P_max.

After the power setpoint has been regulated, the value of the duty cycle PWM_(sub)system of the control signal is again noted and compared with the corresponding detection threshold value PWM_(sub)system_lim_j, which in this example is 52%. If the noted value of the duty cycle PWM_(sub)system of the control signal is higher than this new detection threshold value PWM_(sub)system_lim_j, for example if it is equal to 55%, the first phase P1 is reactivated and the power setpoint is decreased by 1/16 thereby again passing to 60% of the maximum power P_max.

In contrast, if the noted value of the duty cycle PWM_(sub)system of the control signal is lower than or equal to the new detection threshold value PWM_(sub)system_lim_j, for example if it is equal to 52%, the second phase P2 may be reiterated to increase the power setpoint P_(sub)system_target_j to 70% of the maximum power P_max, and so on.

As above, the possible iterations j of the second regulating phase P2 are limited. The second regulating phase P2 may be reiterated until the permitted maximum setpoint value is reached, and for example until the permitted maximum power-setpoint value or the non-limited prevailing setpoint, which may or may not be the initial value P_(sub)system_target_0, which may by way of nonlimiting example correspond to 80% of the maximum power P_max, is reached. The prevailing setpoint may have changed with respect to the initial setpoint.

If the regulated setpoint value P_(sub)system_target_j reaches this prevailing setpoint value, for example if j=0, at the end of step E9, the second phase P2 and the thermal management strategy are stopped. The method is reiterated from the start.

In the contrary case, if the regulated setpoint value P_(sub)system_target_j does not reach the permitted maximum setpoint value or the non-limited prevailing setpoint, for example if j≠0, steps E6 to E9 may be reiterated.

The second regulating phase P2 is advantageously iterated or reiterated with a predefined period, which may be the same as for the first regulating phase P1.

Resumption Phase

With reference to FIG. 4, after the electrical supply of the resistive elements has been cut in step E5, and in particular if, in an iteration of the first regulating phase P1 (derating phase), the regulated setpoint value, which for example is a regulated power-setpoint value P_(sub)system_target_i in FIG. 4, reaches the limit setpoint value, which for example is a power limit setpoint value P_(sub)system_target_m in FIG. 4, i.e. if i=m, the method may comprise a step of generating a command to resume the electrical supply of the resistive elements.

The command to resume electrical supply may be generated at the end of the predefined stoppage time, which may be around 2 min, for example 130 s.

Alternatively, the command to resume electrical supply may be dependent on at least one predefined criterion. In this case, the method also comprises one or more steps of verifying such a criterion.

The criterion is for example the temperature of the electrical circuit carrier on which is mounted the electrical supply circuit of the resistive elements. In this case, in a step E11, the temperature T_PCB of the carrier of the electrical supply circuit of the resistive elements may be noted. The temperature of the carrier of the electrical circuit is noted, for example via a temperature sensor, such as a thermal probe with a negative temperature coefficient.

The method may comprise one or more steps of determining, depending on the noted temperature T_PCB of the carrier, whether the one or more subsets of resistive elements are in a minimum heating state.

In a first embodiment, the noted temperature T_PCB of the carrier is compared, in step E12, with a predefined limit temperature T_lim representative of minimum heating. By way of example, the predefined limit temperature T_lim is equal to or about 70° C.

If the noted temperature T_PCB of the carrier is lower than the predefined limit temperature T_lim, i.e. if minimum heating is not detected, the first regulating phase P1 is not reactivated and the method may be reiterated from the start. In the absence of detection of a minimum heating state, the electrical supply may restart with a setpoint corresponding to the minimum between the setpoint received from the control unit controlling the resistive elements and the permitted maximum setpoint. The change of the duty cycle PWM_(sub)system of the pulse-width-modulated control signal may be monitored in order to detect overheating of resistive elements of the electrical heating device.

Conversely, if the noted temperature T_PCB of the carrier is higher than or equal to the predefined limit temperature T_lim, the method may comprise a step E13 in which the setpoint received from the control unit controlling the resistive elements is compared with a predefined resumption setpoint value. Advantageously, this predefined resumption setpoint value is lower than or equal to the permitted maximum setpoint value. This resumption setpoint value is defined independently of the table of duty-cycle values. For example, in the case of a power setpoint, the resumption power-setpoint value may be 55% of the maximum power setpoint.

If the setpoint received from the control unit is lower than the resumption setpoint value, for example 55% of the maximum power setpoint (arrow Y), it is not necessary to regulate the setpoint in the first phase P1 (power-setpoint derating phase). The first regulating phase P1 is not reactivated and the method may be reiterated from the start, according to the setpoint received from the control unit controlling the resistive elements.

Conversely, if the setpoint received from the control unit is higher than or equal to the resumption setpoint value, for example 55% of the maximum power setpoint (arrow N), in this case the setpoint is limited, in step E14, to this resumption setpoint value. The electrical supply of the resistive elements therefore restarts with a limited setpoint value, set to the predetermined resumption value, and the first regulating phase P1 is reactivated.

Subsequently, depending on the situation, it is possible on resumption for the setpoint to be regulated upward, i.e. the second phase P2, which corresponds to an uprating phase in the particular example described of a power setpoint of PTC resistive elements, occurs—this is especially the case if the system is cold enough (blown air). The setpoint may also on resumption be regulated downward, i.e. the first phase P1, which corresponds to a derating phase in the preceding example, occurs.

In a second embodiment, the variation ΔT_PCB in the temperature of the carrier of the electrical supply circuit of the resistive elements may be monitored over a predefined period of time, for example over the predefined stoppage time of the electrical supply of the resistive elements. In step E12, this variation ΔT_PCB in the temperature of the carrier is compared with a predefined limit temperature variation ΔT_lim representative of minimum heating of the electrical heating device. The predefined limit temperature variation ΔT_lim is for example equal to or about −10° C.

If the temperature variation is lower than the predefined limit temperature variation, in the preceding example, if the temperature has decreased by 10° C. or more, the temperature decrease is considered sufficient and the first regulating phase P1 is not reactivated. The method may be reiterated from the start, according to the setpoint received from the control unit controlling the resistive elements.

Conversely, if the temperature variation is higher than or equal to the predefined limit temperature variation, in the preceding example, if the temperature has not dropped by 10° C. or more, in step E13, the setpoint received from the control unit may be compared with the predefined resumption setpoint value. As described previously, if the setpoint received from the control unit is lower than the resumption setpoint value, (arrow Y), it is not necessary to regulate the setpoint in the manner of the first phase P1. Otherwise, the setpoint is limited in step E14 to the resumption setpoint value, and the first regulating phase P1 is reactivated.

Initial Detection of Overheating

Moreover, with reference to FIG. 5, prior to the activation of the first regulating phase P1, overheating of at least one subset of resistive elements of the electrical heating device may be detected when the duty cycle PWM_(sub)system of the pulse-width-modulated control signal passes beyond a predefined detection threshold value of the duty cycle of the pulse-width-modulated control signal PWM_(sub)system_lim, which value is representative of overheating. To do this, the following steps may be implemented.

In a preliminary step, a condition regarding whether the temperature or temperature variation of the electrical circuit carrier on which the electrical supply circuit of the resistive elements is mounted is sufficient may be checked in order to ensure that the resistive elements are in a minimum heating state. This may be done in a way similar to that employed in steps E11 and E12 described above.

In a step E100, the duty cycle PWM_(sub)system of the pulse-width-modulated control signal of a subsystem, or of all the resistive elements, may be noted.

In step E101, the noted value of the duty cycle PWM_(sub)system of the pulse-width-modulated control signal may be compared with a detection threshold value PWM_(sub)system_lim of the duty cycle of the pulse-width-modulated control signal of the predefined number of resistive elements, the detection threshold value being representative of overheating of the electrical heating device. This detection threshold value PWM_(sub)system_lim of the duty cycle may be defined at least depending on the setpoint (preferably the power setpoint). In particular, the detection threshold value PWM_(sub)system_lim is defined depending on the pair consisting of the supply voltage and of the setpoint.

Overheating is detected depending on the result of the comparison. More precisely, overheating of the device is detected if the noted value of the duty cycle PWM_(sub)system passes beyond the defined detection threshold value PWM_(sub)system_lim of the duty cycle, such as to be higher or lower than it, depending on the nature of the resistive elements. For resistive elements of positive temperature coefficient PTC for example, overheating is detected when the noted value of the duty cycle PWM_(sub)system is higher, and for example strictly higher, than the defined detection threshold value PWM_(sub)system_lim of the duty cycle. In this case, the first regulating phase P1 described above is activated. Conversely, if the noted value of the duty cycle PWM_(sub)system is lower than or equal to the detection threshold value PWM_(sub)system_lim of the duty cycle, overheating is not detected and the first regulating phase P1 is not activated.

As a variant or in addition, one or more other parameters, for example depending on current, may be used to monitor overheating of the electrical heating device.

When the resistive elements are resistive elements of negative temperature coefficient (NTC), the ratios are inverted with respect to resistive elements of positive temperature coefficient (PTC). Thus, for example, for NTC resistive elements, overheating is detected if the noted value of the duty cycle PWM_(sub)system is lower than the detection threshold value PWM_(sub)system_lim, or PWM_(sub)system_lim_i during iteration of the first regulating phase P1, or PWM_(sub)system_lim_j during iteration of the second regulating phase P2.

In the above description, steps E0 to E14 are indexed. It is a question of simple indexing for differentiating between and designating the various steps of the method. This indexation does not necessarily imply a priority of one step over another. The order of certain steps of this method may be inverted without departing from the scope of the present description. This indexation does not imply an order in time either. Some steps may for example be carried out at the same time.

Control Unit

The thermal management method such as described above may be implemented by a control unit (not shown in the figures). It is a question of an electronic control unit. In particular, the thermal management method may be implemented by the control unit already used to control the heating modules of the electrical heating device and/or to detect overheating.

The control unit comprises at least one processing means for implementing the steps of the thermal management method described above with reference to all the figures.

Generally, the control unit may comprise one or more processing means such as a computing means or microprocessor for activating, if overheating is detected beforehand, a first phase P1 of regulating the setpoint in a first direction of change. The one or more processing means are also configured to activate a second phase P2 of regulating the setpoint in a second direction of change, when overheating is no longer detected after one or more iterations of the first regulating phase P1.

In particular, the control unit comprises one or more processing means for noting the power setpoint, or temperature setpoint, or current setpoint, or resistance setpoint, and for regulating the setpoint, for example by decreasing or increasing it, depending on the regulating phase P1 or P2 in process of being carried out.

The control unit may comprise a comparator for comparing a user's setpoint request with a permitted maximum setpoint, or even with a predefined resumption setpoint following a stoppage of the electrical supply of the resistive elements.

The control unit for example comprises a sensor for measuring voltage, in order to measure or note the supply voltage U_battery.

The control unit for example comprises a processing means for determining or noting the duty cycle PWM_(sub)system of the pulse-width-modulated control signal of the predefined number of resistive elements.

The control unit may comprise, for example, a computer for determining a detection threshold value PWM_(sub)system_lim, or PWM_(sub)system_lim_i, or PWM_(sub)system_lim_j, of the duty cycle of the pulse-width-modulated control signal of the predefined number of resistive elements, the threshold value being representative of overheating of the electrical heating device and being defined depending on the setpoint, or as a variant depending on the pair consisting of the supply voltage and of the setpoint.

The control unit for example comprises at least one comparator for comparing the noted value of said duty cycle PWM_(sub)system with the detection threshold value PWM_(sub)system_lim, or PWM_(sub)system_lim_i, or PWM_(sub)system_lim_j.

This comparator or another comparator may be configured to compare a regulated setpoint value with a limit setpoint value not to be passed beyond during the implementation of the first regulating phase P1.

The control unit may comprise a computing means or a microprocessor for determining, depending on the results of the comparisons, whether overheating has occurred. In particular, the microprocessor may evaluate whether the noted value of said duty cycle has reached or even passed beyond (such as to be higher or lower depending on the nature of the resistive elements) the defined detection threshold value of the duty cycle, in order to detect overheating and to activate or reiterate the first regulating phase P1. The microprocessor may evaluate when the noted value of said duty cycle is no longer beyond (such as to be higher or lower depending on the nature of the resistive elements) the defined detection threshold value of the duty cycle, in order to activate the second regulating phase P2.

The control unit may comprise another or the same computing means or microprocessor for generating a command to stop the electrical supply of the resistive elements for a predefined stoppage time, when a regulated setpoint value reaches the limit setpoint value defined for the first regulating phase P1.

The control unit may also comprise at least one processing means for verifying whether a criterion of the electrical heating device is representative of a minimum heating state. For example, it is possible to provide a sensor of the temperature of the carrier of the supply circuit of the resistive elements. The control unit may comprise this additional temperature sensor. Such a temperature sensor may be placed on, for example by being soldered, brazed, or adhesively bonded to, the printed circuit board (PCB). It may be a question of a thermal probe of negative temperature coefficient (NTC), the electrical resistance of which decreases uniformly with temperature. Alternatively, it could be a question of a thermal probe of positive temperature coefficient (PTC), the electrical resistance of which increases sharply with temperature.

The control unit may comprise, for example, a comparator for comparing the noted temperature T_PCB of the carrier of the electrical circuit, or a temperature variation ΔT_PCB, with a predefined threshold T_lim, or a limit temperature variation ΔT_lim, respectively, corresponding to minimum heating of the electrical heating device.

The or another computing means or microprocessor may, depending on the results of the comparisons, reactivate the first regulating phase P1, advantageously taking into account a limited setpoint, when the temperature T_PCB or the temperature variation ΔT_PCB of the carrier of the electrical circuit corresponds to minimum heating.

Thus, by gradually regulating the setpoint, the power setpoint for example, and by adapting in each stage of regulation the detection threshold value of the duty cycle of the pulse-width-modulated control signal, the method according to the invention allows action to be taken in real time in case of overheating in order to prevent the electrical heating device from reaching a critical temperature level that would run the risk of causing damage to certain surrounding components.

1. A thermal management method to be applied in case of detection of overheating of an electrical heating device, in particular for a motor vehicle, said device comprising a plurality of resistive elements configured to be supplied electrically by an electrical voltage source, wherein the electrical supply of at least one subset of resistive elements is controlled using a pulse-width-modulated control signal depending on a power setpoint, or temperature setpoint, or current setpoint, or resistance setpoint, the method comprising:
activating a first phase of gradually regulating said setpoint in a first direction of change, the first regulating phase comprising:
regulating said setpoint in first predefined increments,
for each regulated setpoint value determining, for the duty cycle of said control signal, a corresponding detection threshold value representative of overheating of said at least one subset of resistive elements, depending on the regulated setpoint value,
in each iteration of the first regulating phase, observing the duty cycle of said control signal and comparing it with the determined corresponding detection threshold value of the duty cycle of said control signal, and
reiterating the first regulating phase as long as the observed duty cycle of the pulse-width-modulated control signal is beyond the determined detection threshold value, and otherwise activating a second phase of regulating said setpoint, in a second direction of change opposite to the direction of change of the first phase.

2. The method as claimed in claim 1, wherein the first phase is a phase of derating said setpoint in a first direction of change, comprises:
limiting said setpoint in first predefined increments allowing a derating level i to be reached;
for each limited setpoint value, determining, for the duty cycle of said control signal, a corresponding detection threshold value representative of overheating of said at least one subset of resistive elements, depending on the limited setpoint value;
in each iteration of the derating first phase, observing the duty cycle of said control signal and comparing the observed duty cycle with the determined corresponding detection threshold value of the duty cycle of said control signal.

3. The method as claimed in claim 1, wherein the second regulating phase is gradual and comprises:
regulating said setpoint in second predefined increments;
for each regulated setpoint value, determining, for the duty cycle of said control signal, a corresponding detection threshold value representative of overheating;
in each iteration of the second regulating phase, observing the duty cycle of said control signal and comparing the observed duty cycle with the determined corresponding detection threshold value of the duty cycle of said control signal; and
if the observed duty cycle of the pulse-width-modulated control signal is beyond the determined detection threshold value, reactivating the first regulating phase, otherwise, reiterating the second phase of regulating said setpoint.

4. The method as claimed in claim 3, wherein the second regulating phase is an uprating phase comprises:
increasing said setpoint in second predefined increments,
for each increased setpoint value, determining, for the duty cycle of said control signal, a corresponding detection threshold value representative of overheating,
in each iteration of the uprating second phase, observing the duty cycle of said control signal and comparing the observed duty cycle with the determined corresponding detection threshold value of the duty cycle of said control signal,
if the observed duty cycle of the pulse-width-modulated control signal is beyond the determined detection threshold value, reactivating the derating first phase, and otherwise reiterating the uprating second phase.

5. The method as claimed in claim 1, further comprising
measuring the supply voltage, wherein the detection threshold value of the duty cycle of said control signal is also determined depending on the measured supply voltage.

6. The method as claimed in claim 1, further comprising:
during the first regulating phase, comparing the regulated value of said setpoint with a limit setpoint value; and
if the regulated value of said setpoint reaches the limit setpoint value, generating a command to stop the electrical supply of said at least one subset of resistive elements for a predefined stoppage time.

7. The method as claimed in claim 6, further comprising: generating a command to resume the electrical supply of said at least one subset of resistive elements with a resumption setpoint set to a predetermined value lower than or equal to a permitted maximum setpoint value.

8. The method as claimed in claim 1, further comprising:
observing the temperature of a carrier of the electrical supply circuit of the resistive elements; and
determining depending on the observed temperature whether said at least one subset of resistive elements is in a minimum heating state; and
activating the first regulating phase when a minimum heating state of said at least one subset of resistive elements is determined.

9. The method as claimed in claim 7, wherein:
the temperature of said carrier is observed subsequently to the predefined stoppage time of the electrical supply of said at least one subset of resistive elements, and
the command to resume the electrical supply of said at least one subset of resistive elements is generated with a resumption setpoint if a minimum heating state of said at least one subset of resistive elements is determined, depending on the observed temperature of said carrier.

10. The method as claimed in claim 1, wherein the resistive elements are resistive elements of positive temperature coefficient, the setpoint is a power setpoint, and wherein:
the first regulating phase is a derating phase in which the power setpoint is gradually decreased in the first predefined increments as long as the observed oduty cycle of the pulse-width-modulated control signal is higher than the detection threshold value determined in the first regulating phase, and
the second regulating phase is an uprating phase in which the power setpoint is increased when the observed duty cycle of the pulse-width-modulated control signal is lower than or equal to the detection threshold value determined in the second regulating phase.

11. The method as claimed in claim 1, wherein the first regulating phase and/or second regulating phase are/is iterated with a predefined period.

12. The method as claimed in claim 1, wherein said first and/or second predefined increments are constant.

13. The method as claimed in claim 1, wherein said first and/or second predefined increments are variable.

14. The method as claimed in claim 1, wherein:
at least two subsets of separate resistive elements are controlled independently by pulse-width modulation of the electrical supply, and
for each subset, a detection threshold value of the duty cycle of the control signal is defined independently, depending on the nature and/or the number of the resistive elements of the subset.

15. A control unit for an electrical heating device comprising”
a plurality of resistive elements configured to be electrically supplied by an electrical voltage source,
the control unit being configured to generate a pulse-width-modulated control signal for controlling the electrical supply of the resistive elements depending on a power setpoint, or a temperature setpoint, or a current setpoint, or a resistance setpoint; and
at least one processing means for:
activating a first phase of gradually regulating said setpoint in a first direction of change, the first regulating phase comprising:
regulating said setpoint in first predefined increments,
for each regulated setpoint value determining, for the duty cycle of said control signal, a corresponding detection threshold value (PWM_(sub)system_lim_i) representative of overheating of said at least one subset of resistive elements, depending on the regulated setpoint value,
in each iteration of the first regulating phase, observing the duty cycle of said control signal and comparing the observed duty cycle with the determined corresponding detection threshold value of the duty cycle of said control signal,
reiterating the first regulating phase as long as the observed duty cycle of the pulse-width-modulated control signal is beyond the determined detection threshold value, but otherwise activating a second phase of regulating said setpoint, in a second direction of change opposite to the direction of change of the first phase.
